(19) United States
(12) Patent Application Publication
(10) Pub. No.: US 2005/0052996 A1
(43) Pub. Date: Mar. 10, 2005

(54) Method and apparatus for management of voice-over IP communications

(75) Inventors: David J. Houck, Colts Neck, NJ (US); Eunyoung Kim, Eatontown, NJ (US); Huseyin Uzunalioglu, Red Bank, NJ (US); Larry A. Wehr, Piscataway, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/657,864

(22) Filed: Sep. 9, 2003

(51) Int. Cl. H04L 12/26

(52) U.S. Cl. 370/230; 370/352

(57) ABSTRACT

A method and apparatus for analyzing current voice call quality in an IP network before allowing a new voice call to enter therein. Circuitry in each gateway between a PSTN and the IP network obtains information from the IP network regarding the quality of voice call traffic being transmitted from one gateway to another gateway. A parameter is calculated by the circuitry based on this information. This parameter is compared to predetermined thresholds to guarantee acceptable quality for a new voice call that is attempting to enter the IP network. The circuitry includes three circuits. A first circuit passes voice call data to the IP network. A second circuit polls the IP network about traffic information transmitted therein. A third circuit processes the polled information to determine whether the voice call data is to be accepted by the IP network.

### FIELD OF THE INVENTION

The invention relates to the field of communications systems and more specifically to the management and admission control of voice over IP (VoIP).

### DESCRIPTION OF THE BACKGROUND ART

Telecommunications networks and other networks are increasing in both size and complexity in order to serve the growing demand for high-speed communication networks for the transfer of voice and/or data information. As these telecommunication networks grow, alternate solutions or networks are sought to meet the demand for increasing network bandwidth and new IP-based services.

Traditionally, voice calls are transported entirely over the end-to-end, circuit-based Public Switched Telephone Network (PSTN). However, considerable attention has been directed toward the implementation of real-time communication across computer data networks, and particularly the ability to route voice traffic to and from the PSTN. Interest has also been raised in using Voice over IP (VoIP) solutions to facilitate voice communication between originating and terminating PSTN end points via an IP network. Using the Internet for long haul routing substantially bypasses the PSTN.

For PSTN bypassing applications, voice traffic is processed into IP (or ATM) packets, transported over an IP network (or ATM network), and then processed back to PCM voice. To facilitate such call routing, originating and terminating End Office (EO) switches can be connected to PSTN/IP (or PSTN/ATM) gateways that reside as hosts on the IP (or ATM) network. Based on the called number or other signaling indicator, the EO switches route certain calls through the IP (or ATM) gateways instead of the PSTN.

Unfortunately, when a new VoIP telephone voice call is established (with the intent of it being routed between two gateways in the network), there are no means to evaluate the level of congestion of the core IP network. In other words, it is possible to have too many new voice calls being introduced to the network at the same time so that the core IP network is overloaded. Under such a condition, it is highly likely that packets of information that contain the voice data will either be lost or delayed from arriving at the destination gateway. Both of such conditions result in poor Quality of Service (QoS) of the network which is an undesirable.

Two possible solutions to ascertaining the level of congestion of the core IP network is to overprovision the network such that packet loss will not occur and to reserve sufficient bandwidth between gateways and count voice calls on each path. However, the first solution requires expensive overbuilding of the network and the second solution is relatively complex to operate. Accordingly an improved means for establishing an admission policy of voice calls to a network is desirable.

### SUMMARY OF THE INVENTION

The disadvantages heretofore associated with the prior art are overcome by a novel method and apparatus for analyzing the level of voice call traffic in an IP network before allowing a new voice call to enter the IP network.

In particular, in one embodiment, analysis circuitry is provided to each gateway between a PSTN and the IP network. Such circuitry obtains information from the IP network regarding the level of voice call traffic being transmitted from one gateway to another gateway. A parameter is calculated by the analysis circuitry based on obtained information. This parameter is then compared to predetermined thresholds to guarantee acceptable quality for a new voice call that is attempting to enter the IP network. If the value of the parameter is below a lower threshold, voice call quality is highly acceptable and the new voice call is allowed into the IP network. If the value of the parameter is between the lower threshold and an upper threshold, voice call quality is acceptable, but the new voice is allowed into the IP network at a reduced bandwidth in comparison to existing calls in the network whose parameter was below the lower threshold. If the value of the parameter is above the upper threshold, voice call quality will be unacceptable and the new voice is not allowed into the IP network.

In one embodiment, the parameter is a packet loss ratio (PLR). The PLR considers lost, late and received packets measured at a particular gateway along a particular path and reported back to a gateway that had sent such packets. The PLR is calculated by the equation A/(A+B) where A is the sum of lost and late packets arriving at the particular gateway along the particular path and B is the total number of successfully received packets arriving at the particular gateway along the particular path.

In particular, the apparatus includes a gateway for interfacing voice call data from a PSTN to an IP network. The gateway further includes a first circuit for passing said voice call data to the IP network, a second circuit for polling the IP network about traffic information transmitted therein and a third circuit for processing the polled information to determine whether the voice call data is to be accepted by the IP network.

In one embodiment, the first circuit includes one or more interface cards that are connected to the IP network and the second circuit is at least one strongarm card connected to said interface card via a host CPU circuit. The third circuit compares the parameter (PLR) based on the polled information to the upper and lower thresholds to make the appropriate decision of allowing, blocking or allowing at reduced bandwidth a new voice call. In doing so, quality of all calls on the network is maintained and new calls are not permitted into the network until such time that their quality is at minimum requirements.

### BRIEF DESCRIPTION OF THE DRAWINGS

The teachings of the present invention can be readily understood by considering the following detailed description in conjunction with the accompanying drawings, in which:

FIG. 1 depicts a general overview of a communication network that employs the subject invention;

FIG. 2 depicts a schematic view of a portion of the communication network shown in FIG. 1;

FIG. 3 depicts a detailed schematic view of a portion of one of the gateways depicted in either of FIG. 1 or 2 detailing the interconnection of the subject invention therewith;

FIG. 4 depicts a call set flow diagram that operates in accordance with the subject invention;

FIG. 5 depicts a graph of offered load in a communication system employing the subject invention versus the probability of a blocked call;

FIG. 6 depicts a graph of the update interval of status reports generated in accordance with the subject invention versus the blocking ability;

FIG. 7 depicts a graph of the number of consecutive packets that are lost in a communication network versus the percentage of loss of said packets;

FIG. 8 depicts a flow chart of a call admission process of the subject invention; and

FIG. 9 depicts a flow chart of a process for updating a rules database associated with the subject invention.

To facilitate understanding, identical reference numerals have been used, where possible, to designate identical elements that are common to the figures.

### DETAILED DESCRIPTION

The subject invention establishes and manages VoIP traffic in a network (for example an Internet Protocol (IP) network) by monitoring certain criteria indicative of network capability and instantaneous load. Accordingly, an exemplary telecommunications system is described as one potential environment in which a subject invention operates and exists.

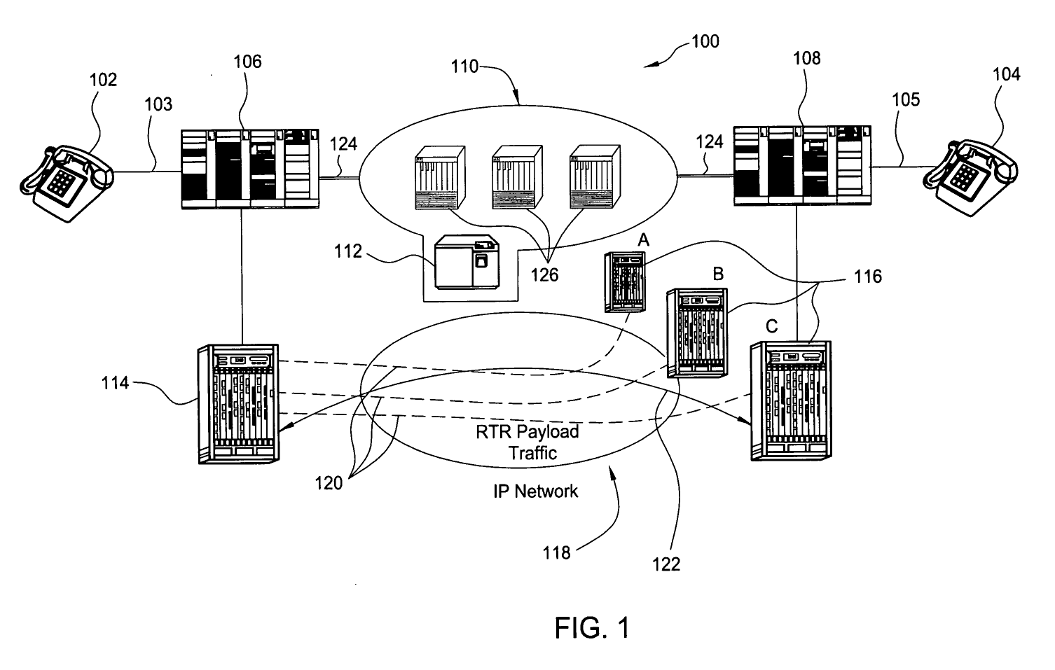

FIG. 1 depicts an exemplary telecommunications system 100 for routing telephone calls between a first wire line subscriber 102 and a second wire line subscriber 104 in a PSTN 110. Such telephone calls are routed across an intermediate data network 118 implementing a network layer protocol, such as IP (or a link layer protocol such as asynchronous transfer mode (ATM) or both). The telecommunications system 100 includes a first subscriber end office unit 106 connected to the first subscriber 102 and a second end office 108 connected to the second subscriber 104. Interconnection of these components is achieved via conventional local loop subscriber lines (103 and 105 respectively). For example, such first subscriber line 103 and second subscriber line 105 would typically be implemented using two-element twisted pair wires carrying analog information or basic rate ISDN digital information depending on the configuration of the wire lines subscriber units 102 and 104. Communication between the PSTN 110 and first end office 106 and second end office 108 would typically utilize trunk groups 124 carrying PCM digital voice traffic on multiplexed channels at a primary rate of 1.544 MBPS, 2.048 MBPS or better via a plurality of switches 126.

It is also possible to bypass the PSTN 110 using the data network 118. Such an alternate communication path is established by connecting the first end office 106 to a first gateway 114 and likewise connecting the second end office unit 108 to a second gateway 116. First gateway 114 and second gateway 116 may be a single unit (as shown as a single structure 114 or may be represented by one or more independent structures A,B and C of second gateway 116. First and second gateways 114 and 116 respectively reside as hosts on the network 118. They provide VoIP services on behalf of the first wire line subscriber 102 and second wire line subscriber 104 and other users (not shown) communicating over the network 118. During VoIP communications between the first wire line subscriber 102 and the second wire line subscriber 104, PCM traffic is routed from the first end office 106 and second end office 108 to the respective gateways 114 and 116 for routing across the data network 118. Call control is managed through the Softswitch 112. When a new call is set up or a completed call is torn down, signaling messages are exchanged between the first end office 106 and the Softswitch 112 and between the Softswitch 112 and the second end office 108. The Softswitch 112 also acts as a gateway controller and exchanges messages with each gateway. In some networks there may be different Softswitches 112 controlling each gateway(114, 116 or the like) and these Softswitches exchange signaling messages with each other.

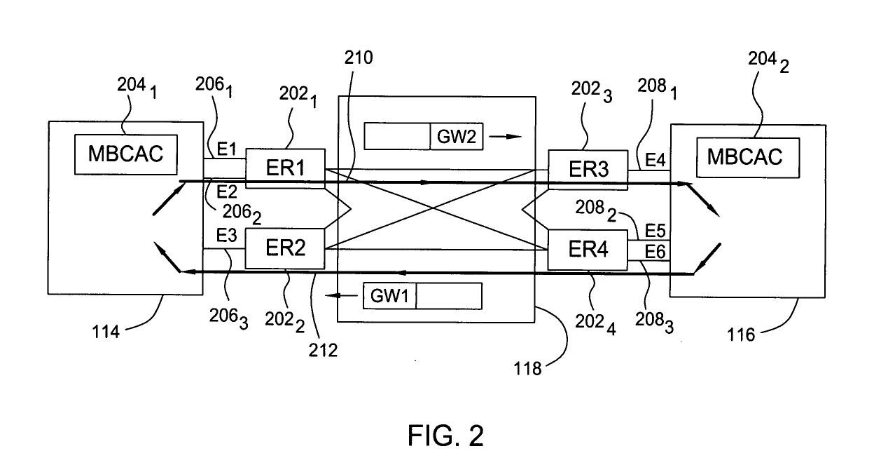

FIG. 2 depicts a detailed schematic of the first and second gateways (114 and 116 respectively) and their interconnection within the IP network 118. Specifically, first gateway 114 includes a plurality of ports 206ₓ that provide access to and from the network 118. Similarly, the second gateway 116 also has a plurality of ports 208ₓ for interfacing with the network 118. Between the first gateway 114 and network 118 and the second gateway 116 and the network 118 there may be one or more edge routers 202ₓ that exist to manage the traffic flow between the respective gateways and the network 118. Specifically, data paths are established between the first gateway 114 and for example first edge router 2021 (denoted as E1 and E2). Similar pathways (such as path E3 is established between first gateway 114 and second edge router 2022. Likewise similar pathways are established between the second gateway 116 and a third edge router 2023 (denoted as E4) and a fourth edge router 2024 (denoted as E5 and E6).

Within each gateway (114 and 116) is a corresponding admission control module (first admission control module 204₁ is in first gateway 114 and second admission control module 2042 is in second gateway 116). These admission control modules 204ₓ monitor VoIP traffic and generate the necessary reports to decide which calls will be granted access through the network 118 to maintain overall quality of service for all subscribers. A Measurement-Based Call Admission Control (MBCAC) algorithm contained within said admission control modules 204ₓ is described in greater detail below.

The MBCAC algorithm operates in each gateway (114,116) independent of the other gateways in the network. Call quality statistics for a Real Time Transport Protocol (RTP) stream reflect the congestion status of the path followed by that stream. Thus, by observing these statistics, one can decide on the congestion status of the network paths. FIG. 2 depicts exemplary RTP flows 210 and 212 between two gateways over the IP network 118. Each gateway, (114,116) has a number of DSP chips (described in greater detail below), which convert voice streams in TDM format into IP packets. These packets are sent to destination gateways using the necessary protocols and in one embodiment is a RTP/UDP/IP protocol stack over a link protocol such as PPP.

Packets traveling to a destination gateway can follow different paths based on the port 206ₓ chosen for the specific RTP flow. The MBCAC algorithm assumes that the selection of a port 206ₓ for an incoming call request is under the control of a call controller in the gateway. Hence, the MBCAC algorithm keeps separate admission policies for the paths from different ports to the same destination gateway. It is also assumed that multiple calls going from a particular port to the same destination gateway follows the same path, i.e., there is no load balancing within the network other than provided by the gateways through the selection of an egress port. This assumption can be satisfied if the gateways use the system IP address of the destination gateway as opposed to the IP addresses of its ports. In this framework, load balancing is supported by controlling the egress port at the source gateway (i.e., first gateway 114). Since each egress port would map into a unique path in the IP network 118, the load from source gateway 114 to a destination gateway (i.e., second gateway 116) can be partitioned into different paths, resulting in load sharing in the network.

The destination gateway 116 receives the RTP packets generated by the source gateway 114 (e.g., at port E2) and addressed to itself. For each RTP stream, the receiver measures call quality statistics like packet loss ratio, delay and interarrival jitter for the stream. The measured statistics are sent back to the source gateway 114 periodically in a special field within the RTP packets or in RTCP packets. In one example, these statistics reflect the network conditions for the path following (E2-ER1-Network-ER3-E4). Thus, the MBCAC algorithm utilizes the call quality statistics of this flow to derive the congestion status of the directed path, uniquely defined by the source gateway E2, destination gateway pair.

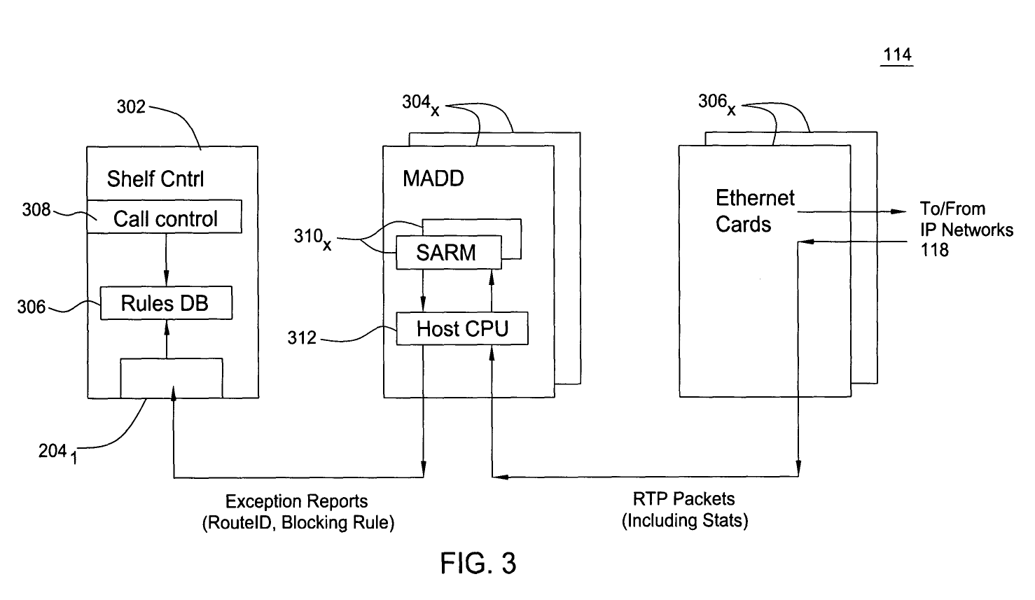

The call quality statistics sent by the destination gateway 116 are collected by an RTP termination point in this gateway and formed into a call quality report. To support the MBCAC function, RTP flows are grouped into sets represented by (Egress port, Remote Gateway)-pair, i.e., there is a list of RTP flows for each (Egress port, Remote Gateway)-pair. Using the example introduced in FIG. 2, there is a set of RTP flows that are uniquely specified by the (source gateway interface E2, destination gateway)-pair. When a call quality report for a particular RTP stream arrives at the source gateway 114, this information is processed based on the (Egress port, Destinations Gateway)-pair. For each such pair, the maximum observed packet loss ratio is reported to the call control logic (as seen in FIG. 3 and explained in greater detail below) periodically. The period for the reporting is referred to as “CAC Update Interval”. At the end of each such interval, the maximum packet loss ratio over the set of RTP flows related to each (Egress port, Destination Gateway)-pair is determined using the most recent measurements for each flow. The result is reported to the call control logic, where the admission control decisions are made. An alternative to periodic reporting of the RTP performance information is to set the thresholds and policy so that only exceptions are reported to the call control logic. This has the advantage of reducing the messaging within the gateway and speeding up the responsiveness of the algorithm to congestion. When there are many flows associated with the same path, it would be computationally expensive to determine the maximum packet loss over all associated flows. To address this problem, the maximum packet loss can be determined for a subset of these flows. Moreover, the CAC Update windows can be made independent for each path.

FIG. 3 depicts a detailed schematic of the internal arrangement and connection of components in one of the gateways associated with the subject invention. Specifically, FIG. 3 depicts the inner connections of elements in first gateway 114; however, this arrangement can also be duplicated in second gateway 116 or any number of other gateways extending from the network 118. The first gateway 114 consists of, among other things, a plurality of circuit cards interconnected in a manner so as to facilitate the passing of information packets to and from the network 118 as well as make determinations on the level of congestion on pathways in which said information packets are passed. The plurality of cards includes a shelf control card 302, one or more MADD cards 304ₓ and one or more port cards 306ₓ. In one embodiment of the invention, the port cards 306ₓ are interface cards operating in accordance with known Ethernet protocols for interfacing with the IP network 118. On each of said MADD cards 304ₓ there is a plurality of strong arm (SARM) cards 310ₓ connected to a host CPU card 312. The shelf control card 302 contains three basic circuit components: the MBCAC algorithm circuitry or processor 204, a rules database 314 and a call control circuit 308. These three components interact with each other as explained in greater detail below to process VoIP traffic and new call requests into the network.

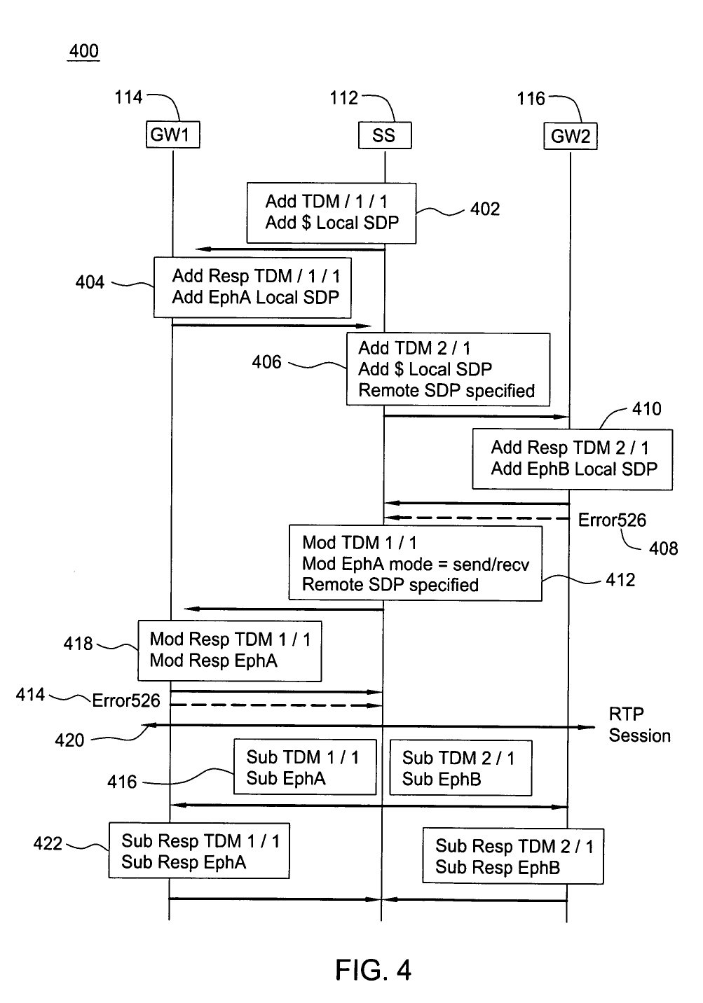

FIG. 4 depicts a call set up signaling scenario between a first gateway 114 and second gateway 116 via soft switch 112 in accordance with the subject invention. While the discussed example of call flow is based on H.248 protocol, it will be understood by those skilled in the art that other types of protocols can be used in conjunction with the subject invention and achieve the desired results. Examples of such additional protocols are selected from the group consisting of SIP and H.323.

The flow diagram begins at step 402 with the soft switch 112 receiving a call set of requests from the PSTN network 110 (as per FIG. 1) resulting in a message being sent to first gateway 114. Said message contains incoming call information that includes which voice trunk of first gateway 114 the voice call will arrive on. At step 404, first gateway 114 creates a RTP port (one of the egress ports 206ₓ) and maps it to the TDM trunk based upon the incoming message from the soft switch 112. First gateway 114 then prepares a response message which contains information including for example context, RTP termination ID, IP address and ports and list of supported codecs chosen from the list presented by soft switch 112. This message is sent back to soft switch 112 acknowledging that the TDM trunk to RTP port mapping has been accomplished.

At step 406, the soft switch 112 sends a message to second gateway 116 that includes the IP address and RTP port of first gateway 114 upon which the call is being set up as well as information about the destination PSTN switch. Since second gateway 116 now has information about first gateway 114, second gateway 116 checks the admission control policy of the path to first gateway 114. If the path is congested, an error message is generated at step 408 indicating that there is insufficient bandwidth to establish the desired path. If the call is to be accepted (i.e., there is sufficient bandwidth available to set up the call), second gateway 116 creates an RTP port (one of the egress ports 206ₓ) and maps this into a voice trunk to the destination PSTN switch. This information is sent back to soft switch 112 as an “add response” message at step 410. This message is forwarded by the soft switch 112 to first gateway 114 so that the RTP port in first gateway 114 can be modified to include a transmit direction. At step 412 the necessary modifications are made to the TDM trunk based on the response from second gateway 116.

Next, first gateway 114 consults with the admission control algorithm to see if there is a path to the second gateway 116 that is not congested. If first gateway 114 is unable to find an uncongested path to second gateway 116 it sends an error message at step 414 to the soft switch 112. In such a scenario where the call attempt has been denied the call set up process is terminated by “subtract command” messages sent by the soft switch 112 to the first and second gateways, 114 and 116 respectively at step 416. In response to the subtract command messages of step 416, first gateway 114 and second gateway 116 provide subtraction command responses to the soft switch 112 at step 422 thereby completing the denied call set up attempt. If there is sufficient bandwidth available to set up the incoming call based on the first gateway 114 admission control algorithm results, a “modify response” message is sent back to the soft switch 112 at step 418. This signals the soft switch 112 that the data path for the voice call is ready for data transmission in both directions. Resultantly, an RTP session is established at step 420 and the voice call begins.

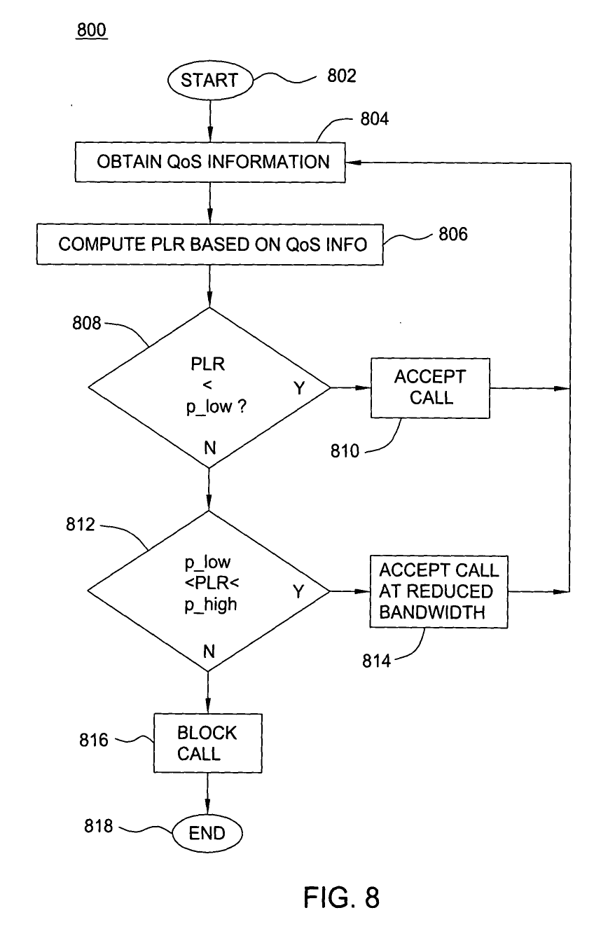

FIG. 8 depicts a flow chart of the decision process executed by the admission control module 204 when practicing the admission policy (MBCAC algorithm in accordance with the subject invention). There are two separate asynchronous processes that operate. One is the updating of admission control policy based on RTP performance reports that are received. The other is the application of the admission control policy when a new call request arrives. Specifically, FIG. 8 depicts the first process whereby the admission control policy is updated. This is shown through a series of method steps 800 that begins at step 802. The method then proceeds to step 804 where quality of service (QoS) information is obtained for further evaluation. In one embodiment of the invention, the host CPU 312 of one of the MADD cards 304ₓ will poll one of the strong arm cards 310 to receive the quality of service information from the network 118. Quality of service information is for example packet loss information (i.e., packets that were known to be transmitted from a first point, for example first gateway 114 but not received at its destination point for example second gateway 116). Once the quality of service information is obtained, the method moves to step 806 where a quality statistic is computed based upon the quality of service information. In one embodiment of the subject invention, the quality statistic is a Packet Loss Ratio which is defined as

$$PLR = \frac{( lost packets + late packets )}{( received packets + lost packets + late packets )}$$

For the purposes of the subject invention, late packets are defined as packets that are discarded at the destination gateway (for example second gateway 116) since they are too late to be played or otherwise incorporated into the active voice call. Additionally, it should be noted that lost, late and received packets (collectively “sent” packets) are defined for the outgoing direction of a voice call, measured by the destination gateway (second gateway 116) and reported back to a source gateway (for example first gateway 114) in the opposite direction. Since each direction of the call takes a separate path through the IP network, there is a separate admission control decision for each direction of the call. All packet counts are defined per RTP connection. Furthermore, packet counts used in the packet loss ratio computation are counts measured over the most recent reporting period. In one embodiment of the invention, the reporting period is approximately two seconds; however, one skilled in the art will realize that various other reporting periods are possible dependent upon hardware and software being used in the overall system and network as long as the desired results are achieved. Other quality information could involve delay or delay variation.

The method continues at step 808 where a first admission policy is established. In one embodiment of the invention, the admission policy consists of two threshold values. In the first decision step 808, the first threshold value (a lower threshold P_low is introduced. The computed PLR is compared to the lower threshold P_low. If the PLR is less than P_low, the method proceeds to step 810 where the policy is set to accept new calls without any limitations. The method then awaits the next reporting period and loops back to step 804 to obtain the new quality of service information to continue evaluation. A reporting period is in the range of approximately 5-60 seconds and in one embodiment is 5 seconds. The exception reporting option will make this updating faster during congestion.

Should the PLR be higher than the lower threshold, the method proceeds to step 812 where the PLR is compared to a second threshold (a high threshold P_high). If the PLR is larger than the lower threshold P_low, but lower than the higher threshold P_high, the method proceeds to step 814 where the policy is set to admit new calls at reduced bandwidth. Such action reduces the bandwidth of new incoming calls to an extent that still allows quality of service. Similar to the accepted call scenario, accepted-bandwidth limited call step 814 loops back to step 804 to await the next reporting period to attain quality of service information.

Should the PLR be higher than the high threshold, the method proceeds to step 816 where the policy is set to block all or some percentage of new call requests from entering the network. In other words, path congestion has reached such a limit that an unacceptable number of packets are either being lost or received too late to be part of a call. As such, it is realized that no new calls can enter the network and maintain an acceptable quality of service level; therefore, such calls are not allowed into the network until path congestion is sufficiently reduced and quality of service can be maintained for all subscribers. The method ends at step 818.

Bandwidth reduction (as discussed above in step 814 of method 800) is achieved in a few different methods. One method is to physically change the encoder that is being used for the particular voice call. That is, there may be two or more encoders in a gateway (114 or 116) that carry out encoding tasks (one encoder having high bit rate characteristics and another having lower bit rate characteristics). If a bandwidth-reduced call is accepted, the encoder with the lower bit rate characteristics is used. When conditions allow for non-bandwidth limited channels, the system can switch back to the higher bit rate encoder. Another way in which bandwidth can be reduced is to use the same codec but increase the packet size. This will reduce the relative packet overhead. Another way of reducing bandwidth as per step 814 is to reduce the bitrate by activating silence suppression for the voice call. Briefly, silence suppression results in reducing bandwidth requirements since no packets are sent during silence periods. In most conversations only one person is talking so that, on average, in any one direction there is speech to send at most half the time. Thus suppressing packets representing silence can save considerable bandwidth. Note that silence suppression does not apply to fax calls, where picking a very large packet size would be more useful.

The above calculations were given in terms of packet loss ratios. The computation of packet loss ratios involve a division operation, which can be avoided if a loss and late packet count is used. In this case, P_low and P_high are converted to low and high packet count thresholds using the packet generation rate of the flow. It is assumed that the sum of received, lost, and late packets will be fixed, and equal to the number of packets transmitted by the local gateway in RTPQOS reporting period. For example, if a codec for a RTP flow is to generate 50 packets per second, there will be 100 packets transmitted every 2-second interval. Using this assumption, it is possible to use the number of lost and late packets instead of packet loss ratio. Thus, it is possible to define packet loss ratio thresholds in terms of packet count thresholds. Continuing in the example, the lower threshold would be (lost+late)_low=100*p_low, and the higher threshold would be (lost+late) high=100*p_high. This way, the SARM 310ₓ can decide if an exception report (a block-call message explained in greater detail below) should be generated or not without performing any division operation. A variation to this would be to use a computed value for the sum of lost and late packets such that this sum is equal to the “Number of packets sent by the local gateway in the RTPQOS reporting interval-local.received”. This way, the inaccuracies related to loss packet estimation in the remote gateway are avoided.

Different RTP flows would have different packet rates; hence, the SARM 310ₓ should take the packet rate of each flow into account. For example, with a 2-second measurement interval 1% packet loss ratio corresponds to only 1 lost packet if the packet rate is 50, while it corresponds to 2 lost packets if the packet rate is 100. The threshold values in terms of number of packets per flow will be provided by the call control during the call set-up. Moreover, if a flow is using silence suppression, the number of packets sent by the local gateway (114 in the above example) should be adjusted to reflect the silence suppression. Quantization of the packets may cause inaccuracies. As such, SARM 310ₓ compares the value of local.received with the expected value, and if there is a large difference, it sets a flag or uses fraction and computes the packet loss ratio. Another technique omits the first set of measurement values for a newly set-up call. This way, the effect of network delay on the expected local.received is avoided.

The SARMs 310ₓ send blocking rules to the admission control module 204₁ in the shelf controller 302 as a result of the analysis conducted by method 800. To reduce the amount of transmitted data, the blocking rules may be reported as exceptions. If the determined admission rule is Accept, nothing is reported to admission control module 204₁. However, if the rule is Reduce or Block, the SARM 310ₓ reports the value to the admission control module 2041 through the host CPU 312 as an exception report. Once an exception report (Reduce or Block) is sent to the admission control module 204₁ for a flow, there should be no reporting for the same RTP flow for a time interval of length T_u, which is called “exception update interval”. This update interval could be different than the periodic update interval if periodic updates are used instead of exception reports. One exception to this rule is if the last reported rule is Reduce and the newly computed rule is Block, the new value should be passed to the admission control module 204₁ immediately. (Note that this is not applicable when Reduce rule is disabled by setting P_low to zero.) In this case, there should be no more reporting for the same RTP flow for a time interval equal to the update interval. A new exception report should be generated if the Reduce or Block rule is determined using a QoS report that was received after the update interval is over. This type of periodic exception reporting should be continued until an Accept rule is detected for the RTP flow. There is no need to report an Accept rule.

An alternative to the exception reporting per RTP is to perform exception reporting per (local interface, remote IP address). This way, the number of update messages can be greatly reduced. This approach results in a maximum of two reports generated within an update interval per (local interface, remote IP address)-pair as opposed to being per RTP flow.

The exception report, delivered to the admission control module 2041, includes the routeID of the flow that the measurement belongs to and the blocking rule. The admission control module 204₁ uses routeID to determine the local interface and remote IP address of the flow. Note that the information regarding the mapping between the routeID and the (local interface, remote IP address)-pair should be located in the shelf controller 302. If this is not possible, the host CPU 312 should provide the explicit information as local interface and remote RTP address when submitting an exception report to the admission control module 2041.

When the admission control module 204, is initialized, the rules database 306 is empty. With time, blocking rules will be reported by the SARMs 310ₓ. This blocking information is kept in the rules database 306 which is used by the admission policy function. An entry in this database is indexed by the Remote IP address. Moreover, each entry consists of subentries. Each subentry contains a blocking rule, an index to a local Ethernet interface, and a timestamp for the subentry. This way, each subentry shows the admission rule for the path defined by (local interface, Remote IP address)—pair. The number of subentries for Remote IP address is variable, where the maximum number is equal to the number of local interface cards, configured in the system. Note that the rules database 306 reflects the congestion status of the network paths from the local gateway to remote gateways. The opposite direction is handled similarly in the remote gateway. When the admission control module 204₁ is initialized, information about the existing interfaces is determined.

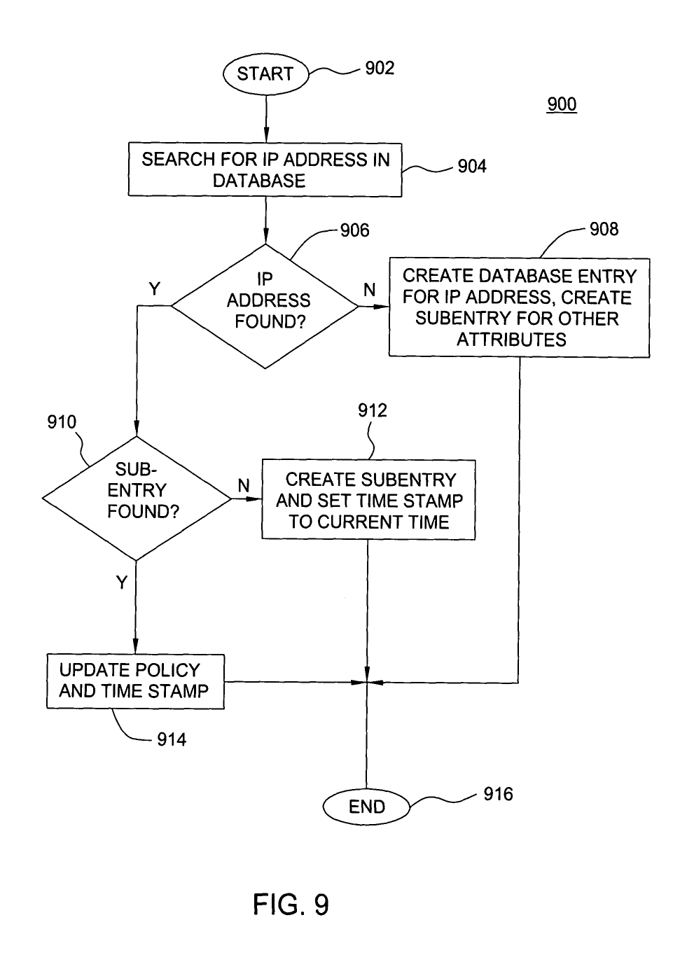

The admission control module 204₁ continuously listens to the exception reports from the host CPUs 312. When an exception report is received for an RTP flow, the blocking rule for the endpoints of the flow is updated. A method of updating the blocking rules is shown in FIG. 9 as a series of method steps 900. Specifically, the method starts at step 902 and proceeds to step 904 where a search of the rules database entries is performed to search for the remote gateway IP address reported in the exception report. The method proceeds to step 906 where a first decision is invoked to determine whether the reported IP address is found. If the remote IP address is not found, the method proceeds to step 908 where a database entry is created for the remote gateway IP address in the exception report. Further in that step, a subentry is created. The subentry includes the index to the local egress ports (e.g., 208ₓ), blocking rule and the timestamp (set equal to the current time). At this step, it is also possible to create other subentries with indices to other local egress ports with a blocking rule of “Accept”. After such entries are created, the method proceeds to step 916.

Should the IP address of the remote gateway be found at step 906, the method proceeds to step 910 where a second decision step is invoked. The second decision step 910 determines if a subentry for the local egress port 208ₓ is found. If such subentry is found, the method proceeds to step 914 where the admission policy is updated and the timestamp is reset to the current time. If the subentry is not found, the method proceeds to step 912 where an appropriate subentry is created and the timestamp is set to the current time. At the conclusion of either of steps 912 or 914, the method proceeds to its final step at 916.

Admission control module 204₁ periodically revises its database to remove subentries that were not updated in the last T_u+Delta seconds. The interval T_u is the time window where the SARMs 310ₓ suppress reporting packet loss values for a connection following a report for the same connection. Here, Delta should be slightly larger than the QoS reporting period of the gateways, so that SARM 310 will have a chance of sending a second exception report before the admission control module 204₁ removes the blocking rule. Delta can be 3 seconds since the RTP QoS reporting is done every 2 seconds. Based on this scheme, the admission control module 204₁ assumes that a path is not congested if there is no exception report within the most recent time interval of length last T_u+Delta seconds. This action is beneficial because the host CPU 312 does not report when the packet loss ratio goes below the threshold value. Reporting of the below threshold value crossing is not needed since there might be more than one flow responsible for the blocking rule, which should be relaxed only if there is no update for the rule in the last T_u+Delta time interval by none of the related flows. Since the mapping of a rule for a path to all the flows, which reported exceptions for the path, would be computationally inefficient, an indirect method is used to remove the blocking condition. The period to revise the database to detect aged blocking rules should be chosen as small as possible to keep the database size small so that search operations will be efficient during a call to function as explained below.

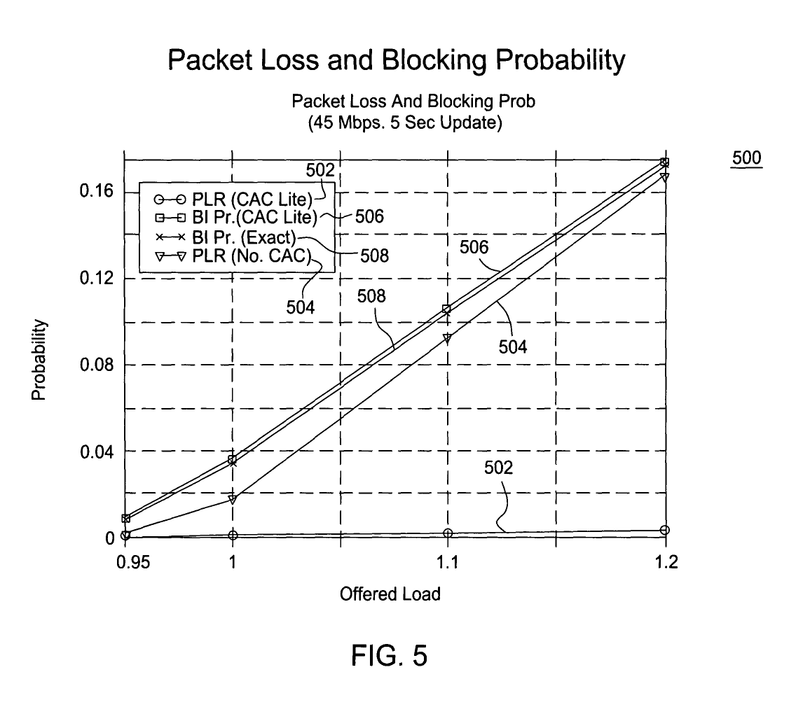

FIG. 5 depicts a graph of the probability of blocking calls and packet loss ratios versus the offered load of the network employing the method and apparatus of the subject invention. That is, graph 500 depicts four plots showing results when using the algorithm of the subject invention. Specifically, the first plot 502 plots the packet loss ratio versus the offered load using the subject invention. It can be seen that as the offered load exceeds up to 20% of network capacity, very few packets are lost (much less than 1% of packets are lost). First plot 502 can be compared to second plot 504 for direct comparison of results of using the subject invention versus not using the subject invention. That is, the second plot 504 plots packet loss ratio without using the admission control protocols or algorithm. As can be seen from the graph 500, as the system capacity approaches 100%, almost 2% of packets are lost. This number grows to more than 16% as offer load increases to 20% over capacity. The third plot 506 plots the call blocking probability when using the admission control algorithm. This plot is compared to fourth plot 508 which plots blocking probability for an ideal algorithm in which the exact configuration of calls that is known. As can be seen, third plot 506 and fourth plot 508 are nearly identical. As such, the algorithm is sufficiently characterized and developed so as to effectively block calls to maintain a quality of service based on current network conditions.

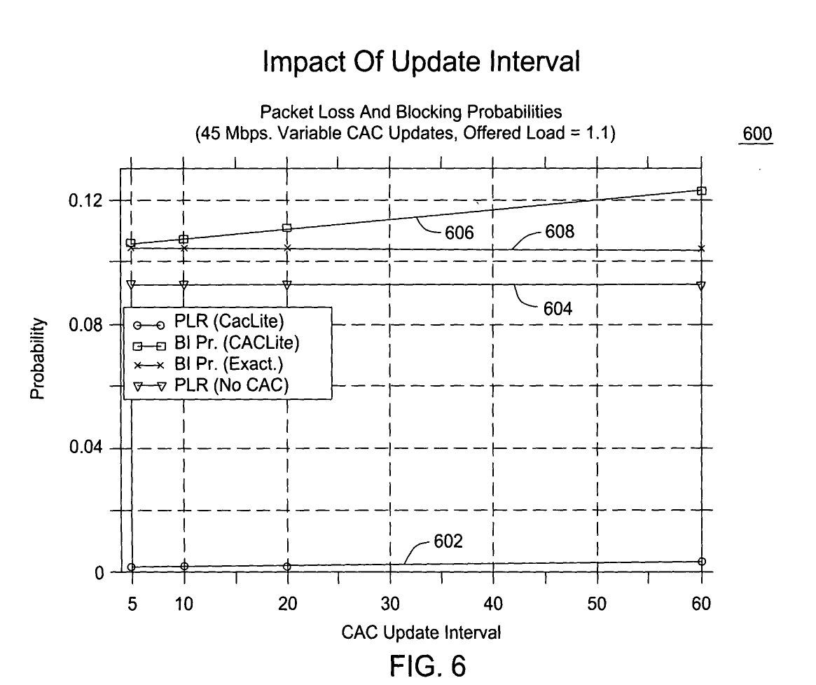

FIG. 6 depicts the corresponding results for the case where the update interval of the reports is varied while the offered load is kept constant at approximately 10% over capacity. Graph 600 depicts four plots that show the results of the packet loss ratio with and without employing the subject invention as well as the blocking probabilities using the subject algorithm. Specifically, first plot 602 shows packet loss ratio using the algorithm in accordance with the subject invention as the update intervals are increased from approximately 5 to 60 seconds. As can be seen, there is very little increase in the packet loss ratio as this parameter is varied. Second plot 604 depicts packet loss ratio without using the algorithm in accordance with the subject invention. As can be seen packet loss ratio is significantly higher when not using the algorithm. Third plot 606 depicts the blocking probability when using the algorithm in accordance with the subject invention while fourth plot 608 depicts the same blocking probability when the exact number of calls moving the network is known. As can be seen by inspection of the third and fourth plots 606 and 608 respectively, the blocking probability tends to increase as the report interval increases. This occurs because once a packet loss ratio of 1% is detected, the admission policy is set to block new call arrivals. All new calls arriving during the update interval thus are blocked (resulting in the increase in blocked call numbers) thus, the admission policy update interval is an important performance variable when examining a blocked call probability more than packet loss ratio.

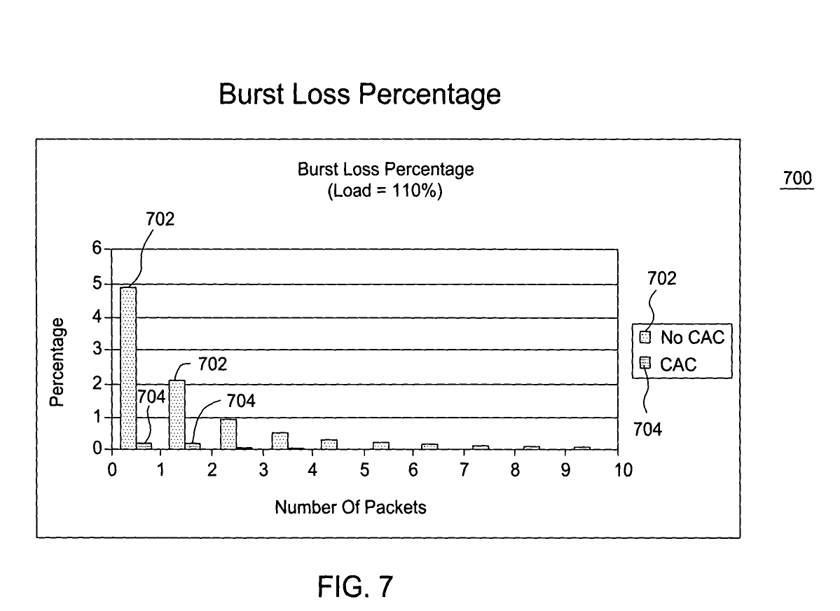

FIG. 7 depicts a graph 700 of packet loss probability in relation to burst losses. In other words, the graph shows the percentage or likelihood of losing a consecutive number of packets when using and not using the algorithm in accordance with the subject invention. Specifically, along the X axis of the graph is an increasing number of consecutive packets lost. The percentage of losing a number of consecutive packets is shown by vertical bars extending upward from the X axis. Lightly colored bars 702 denote percentage of loss of consecutive packets when not using the admission control protocols in accordance with the subject invention. Darker colored bars 704 denote probabilities or percentage of consecutive lost packets when using the admission control protocols. As can be seen, there is a significant number of consecutive packets that are lost when not using the admission control protocols in accordance with the subject invention as opposed to when these protocols are in use. For example, the likelihood of losing three or more consecutive packets when not using the admission control protocols is approximately 1%. However, the likelihood of losing the same number of consecutive packets when using the admission control protocol is nearly zero. Therefore, the admission control protocol or algorithm presents a significant advantage when considering of consecutive lost packets that may occur. This is important as the number of consecutive lost packets can seriously degrade voice call quality.

Although various embodiments which incorporate the teachings of the present invention have been shown and described in detail herein, those skilled in the art can readily devise many other varied embodiments that still incorporate these teachings.

1. A method, comprising the steps of:
(a) obtaining information relevant to the quality of service of voice calls being transmitted from a first location to a second location via an IP network;
(b) calculating a parameter based on said information; and
(c) accepting a new call into the IP network in the case of said parameter not exceeding an upper threshold.

2. The method of claim 1 wherein said new call is accepted into the IP network at a reduced bandwidth in the case of said parameter exceeding a lower threshold.

3. The method of claim 1 where said new call is not accepted into the IP network in the case of said parameter exceeding the upper threshold.

4. The method of claim 1 wherein the information obtained is a number of lost packets, late packets and received packets (collectively defined as “sent” packets) transmitted from said first location to said second location in the IP network.

5. The method of claim 1 wherein the information obtained is a delay of received packets transmitted from said first location to said second location in the IP network.

6. The method of claim 1 wherein the information obtained is a delay variation of received packets transmitted from said first location to said second location in the IP network.

7. The method of claim 1 wherein the information is obtained on a periodic basis.

8. The method of claim 1 wherein the information is obtained on an exception basis using an immediate report.

9. The method of claim 1 wherein the parameter is identified as a packet lost ratio (PLR).

10. The method of claim 9 wherein PLR is defined as
$$PLR = \frac{( lost packets + late packets )}{( received packets + lost packets + late packets )} .$$

11. The method of claim 2 wherein bandwidth is reduced for a newly accepted call by selecting a first encoder to encode the new voice call information in a bandwidth that is smaller than bandwidths of other calls accepted in the network that are encoded by a second encoder.

12. The method of claim 2 wherein the bandwidth of a newly accepted call is reduced by increasing the packet size (voice sample) for said newly accepted voice call.

13. The method of claim 2 wherein the bandwidth of a newly accepted call is reduced by activating the characteristic of silence suppression for said newly accepted voice call.

14. Apparatus comprising a gateway for interfacing voice call data from a public switch telephone network to an internet protocol network; said gateway further comprising:
a first circuit for passing said voice call data to the internet protocol network;
a second circuit for polling the internet protocol network about traffic information transmitted therein; and
a third circuit for processing the polled information to determine whether the voice call data is to be accepted by the internet protocol network.

15. The apparatus of claim 14 wherein said first circuit further comprises one or more Ethernet cards that are connected to the internet protocol network.

16. The apparatus of claim 14 wherein said second circuit is at least one strongarm card.

17. The apparatus of claim 16 wherein the strongarm card is connected to the Ethernet card via a host CPU circuit.

18. The apparatus of claim 14 wherein the third circuit compares a parameter based on the polled information to a plurality of thresholds.

19. The apparatus of claim 18 wherein the parameter is a packet loss ratio defined as
$$PLR = \frac{( lost packets + late packets )}{( received packets + lost packets + late packets )} .$$

20. The apparatus of claim 19 wherein the third circuit compares the packet loss ratio to a lower threshold and if the packet loss ratio is less than the lower threshold, a new voice call is accepted into the internet protocol network.

21. The apparatus of claim 19 wherein the third circuit compares the packet loss ratio to the lower threshold and an upper threshold, and if lower threshold<packet loss ratio<upper threshold, a new voice call is accepted into the internet protocol network at a reduced bandwidth.

22. The apparatus of claim 19 wherein the third circuit compares the packet loss ratio to the upper threshold, and if the packet loss ratio is greater than the upper threshold, a new voice call is blocked from entering the internet protocol network.
